(19) United States
(12) Patent Application Publication
(10) Pub. No.: US 2025/0332946 A1
(43) Pub. Date: Oct. 30, 2025

(54) SYSTEMS AND METHODS FOR ISSUING REMOTE COMMANDS FOR ELECTRIC VEHICLE SUPPLY EQUIPMENTS (EVSES)

(71) Applicant: PowerFlex Systems, LLC, San Diego, CA (US)

(72) Inventors: Hugo RIVERA CALZADILLAS, Santa Fe, NM (US); Javier Nicolás LEDESMA, Cordoba (AR); Pablo Jose SCAGNO, Buenos Aires (AR); Facundo REVELLO, Montevideo (UY); Zachary GOMEZ, Los Altos, CA (US); Loraine FONTALVO, Medellín (CO)

(21) Appl. No.: 19/189,885

(22) Filed: Apr. 25, 2025

Related U.S. Application Data
(60) Provisional application No. 63/640,810, filed on Apr. 30, 2024.

(51) Int. Cl. B60L 53/68; B60L 53/30; B60L 53/67; H04L 67/12

(52) U.S. Cl. CPC B60L 53/68; B60L 53/305; B60L 53/67; H04L 67/12

(57) ABSTRACT

Certain aspects of the present disclosure provide techniques for issuing remote commands for electric vehicle supply equipment (EVSE). In examples, the techniques may include providing a user interface for issuing remote commands to a plurality of EVSEs; receiving, at the user interface, a first input indicative of selection of two or more EVSEs of the plurality of EVSEs; activating a first user interface element for selecting a same command type to issue to the two or more EVSEs based on the two or more EVSEs being in a same state; receiving, at the user interface, a second input indicative of selection of the first user interface element; generating, for each of the two or more EVSEs, a respective command of the command type; and sending, to each of the two or more EVSEs, the respective command.

### CROSS-REFERENCE TO RELATED APPLICATIONS

This Application claims the benefit of and priority to U.S. Provisional Patent Application No. 63/640,810, filed on Apr. 30, 2024, the entire contents of which are hereby incorporated by reference.

### INTRODUCTION

Electric vehicle (EV) charging infrastructure is a rapidly growing field. EV charging stations often rely on backend systems (e.g., backend cloud systems) to manage charging sessions. For example, when an EV connects to an EV charging station, the EV charging station sends a status update to a backend system which then initiates and manages a charging session. The backend system maintains databases of active charging sessions across multiple sites and sends charging parameters down to individual EV charging stations. However, this centralized approach is often hindered by various EV charging stations using different communication protocols or systems. For example, EV charging stations corresponding to a particular manufacturer and/or a specific communication protocol may require a unique method of communication, for example, for controlling various EV charging station functionalities.

To provide a unique method of communication for different EV charging stations can lead to several issues. For example, when a large number of EV charging stations (e.g., those installed at one or more particular customer sites) need to be controlled to, for example, start, stop, or reset, a great amount of resources can be required. As but one example, it may be a very costly effort to separately connect to individual EV charging stations to start, stop, or reset the individual EV charging stations. Further, it may be technically challenging to determine the specific communication protocol that needs to be used for each individual charging station. Such effort may lead to an undesired delay in the EV charging stations being controlled and/or even an unwanted interruption in service of the EV charging stations (e.g., when other ones of the EV charging stations are waiting to be started or reset while a particular one of the EV charging stations is being started or reset). As the EV charging infrastructure continues to expand, these problems are expected to become more pronounced.

### SUMMARY

In accordance with certain embodiments of the present disclosure, a method is provided for issuing remote commands for electric vehicle supply equipments (EVSEs). The method may include: providing a user interface for issuing remote commands to a plurality of EVSEs; receiving, at the user interface, a first input indicative of selection of two or more EVSEs of the plurality of EVSEs; activating a first user interface element for selecting a same command type to issue to the two or more EVSEs based on the two or more EVSEs being in a same state; receiving, at the user interface, a second input indicative of selection of the first user interface element; generating, for each of the two or more EVSEs, a respective command of the command type; and sending, to each of the two or more EVSEs, the respective command.

In accordance with certain embodiments of the present disclosure, another method is provided for issuing remote commands for EVSEs. The method may include: providing a user interface for issuing remote commands to a plurality of EVSEs; receiving, at the user interface, a first input associated with a first action for a first EVSE of a first type; receiving, at the user interface, a second input associated with a second action for a second EVSE of a second type different than the first type; generating, based on the first input, a first command for implementation of the first action for the first EVSE; generating, based on the second input, a second command for implementation of the second action for the second EVSE; sending the first command to the first EVSE; and sending the second command to the second EVSE.

Other embodiments of the present disclosure may provide non-transitory, computer-readable mediums comprising instructions that, when executed by one or more processors of one or more processing systems, cause the one or more processing systems to perform the aforementioned methods as well as those further described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more embodiments.

### DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 depicts a computing environment for managing electric vehicle charging, according to embodiments provided herein;

FIG. 2 depicts a software configuration for an edge environment for managing electric vehicle charging, according to embodiments provided herein;

FIGS. 3A-3C depict device configurations for an edge environment for managing electric vehicle charging, according to embodiments provided herein;

FIGS. 4A-4C depict hardware that may be utilized for the devices from FIGS. 3A-3C, according to embodiments provided herein;

FIG. 5 depicts a device configuration for a cloud environment for managing electric vehicle charging, according to embodiments provided herein;

FIG. 6 depicts a device configuration for a system for issuing remote commands for electric vehicle supply equipments (EVSEs), according to embodiments provided herein;

FIG. 7 depicts internal architecture and logic included within a frontend component of a proxy server for issuing remote commands for EVSEs, according to embodiments provided herein;

FIG. 8 depicts internal architecture and logic included within a backend component of a proxy server for issuing remote commands for EVSEs, according to embodiments provided herein;

FIGS. 9-12 depict example graphical user interfaces for issuing remote commands for EVSEs, according to embodiments provided herein;

FIGS. 13-14 depict example flowcharts illustrating methods for issuing remote commands for EVSEs, according to embodiments provided herein; and

FIG. 15 depicts an example processing system configured to perform the methods described herein.

### DETAILED DESCRIPTION

Embodiments disclosed herein include systems and methods for issuing remote commands for electric vehicle supply equipments (EVSEs) (also referred to herein as charging stations or electric vehicle (EV) charging stations). Some embodiments utilize a user interface (e.g., a graphical user interface) for issuing remote commands for EVSEs. Certain embodiments may utilize an edge computing architecture that handles core EVSE management functionalities on-site, allowing various commands to be issued to multiple EVSEs at a charging site. Furthermore, certain embodiments may utilize a backend system, such as a cloud-based backend system, that handles core EVSE management functionalities remotely, allowing various commands to be issued remotely to multiple EVSEs at one or more charging sites. Though certain examples may be discussed with respect to specific implementations, the techniques used herein may be used with any suitable EVSE control system, such as on-site, cloud-based, or a combination thereof. The systems and methods for issuing remote commands for EVSEs incorporating the same will be described in more detail, below.

Embodiments of the present disclosure may utilize a proxy system (or other similar system) for controlling EVSEs. The proxy system described herein may address potential technical issues related to a service delay or interruption when multiple EVSEs are being, for example, started, stopped, or reset. The use of techniques discussed herein for controlling the EVSEs may provide a technical benefit by eliminating the need for manually connecting to individual EVSEs to cause various actions. In some embodiments, the proxy system described herein may allow multiple EVSEs to be controlled simultaneously. Multiple EVSEs may be controlled in bulk to eliminate the need to manually and individually connect to each of the multiple EVSEs, for example, when a command of the same command type (e.g., to start, stop, or reset) is to be issued to each EVSE.

Moreover, certain embodiments of the present disclosure may utilize the proxy system described herein to perform state-and/or error-checking in order to facilitate various bulk commands to be sent to the EVSEs. For example, the state- and/or error-checking may allow bulk commands to be sent to EVSEs that are ready or available to perform the actions corresponding to the received commands (e.g., of the same command type). By sending the bulk commands to the EVSEs that are ready or available in this manner, the proxy system described herein with respect to certain embodiments may reduce unnecessary resource utilization. For example, certain embodiments of the present disclosure may save, for other purposes, the resources (e.g., in memory) that would have been utilized if bulk commands were sent blindly to multiple EVSEs despite at least some of these EVSEs not being ready or available to perform the actions corresponding to the received commands (e.g., when a stop command is generated and sent to an EVSE that is already stopped). Accordingly, certain embodiments of the present disclosure may allow the issuing of bulk commands to multiple EVSEs to be performed more efficiently and robustly by bypassing the need to control the EVSEs separately. Moreover, certain embodiments may reduce unnecessary resource utilization as well as the potential service delay or interruption which may occur if each EVSE were controlled separately.

Furthermore, certain embodiments of the present disclosure may utilize the proxy system described herein to provide additional capabilities, such as sending commands of a same command type to various EVSEs that are implemented based on different protocols. For example, when some EVSEs are implemented based on a first protocol while other EVSEs are implemented based on a second or another protocol, the proxy system described herein may allow an operator to initiate sending commands of the same command type (e.g., start command type, stop command type, reset command type, etc.) to the EVSEs simultaneously. For example, the operator may be provided a user interface from the proxy system to select multiple EVSEs. Some of these EVSEs may be implemented to support a first communication protocol, while other ones of these EVSEs may be implemented to support a second communication protocol that is different than the first communication protocol. When the multiple EVSEs are selected to send bulk commands of a same command type and the proxy system receives the selection from the operator, certain embodiments of the present disclosure may generate and send to the EVSEs the commands of the same command type. For each of these EVSEs, one or more different commands may be generated, according to the communication protocol that the EVSE supports, to cause the action associated with the command type on the EVSE.

In certain embodiments, the techniques described herein may advance the field of EV charging infrastructure management by providing a proxy system that enables improved efficiency, optimization, and resiliency in controlling the EVSEs, for example, remotely. By enabling the efficient control of EVSEs, certain embodiments of the present disclosure may reduce service delay or interruption traditionally attributable to manually controlling individual EVSEs separately.

Implementing efficient control of the EVSEs via a proxy system may provide capabilities not readily achievable with traditional control systems of EVSEs. In certain embodiments, a proxy system as disclosed herein is capable of receiving, via a user interface, a single instruction of sending bulk commands related to a particular command type to be propagated to multiple EVSEs. The proxy system may also be capable of automatically generating the respective command(s) corresponding to the command type for each of the EVSEs, for example, according to a communication protocol that each EVSE supports, thereby providing technical improvements in controlling the EVSEs.

Further, certain embodiments of the present disclosure may provide a solution to a technical problem related to controlling devices, such as EVSEs, that are using different communication protocols. In particular, certain embodiments provide a single interface that allows a user to select to send a command of a certain command type to an EVSE, regardless of the communication protocol the EVSE supports. Systems described herein may automatically generate the command and send the command to the EVSE. This may ensure that correct commands are sent to an EVSE (e.g., compatible with the communication protocol the EVSE supports), thereby reducing the likelihood of failed commands and control of the EVSE.

### Example Computing Environment

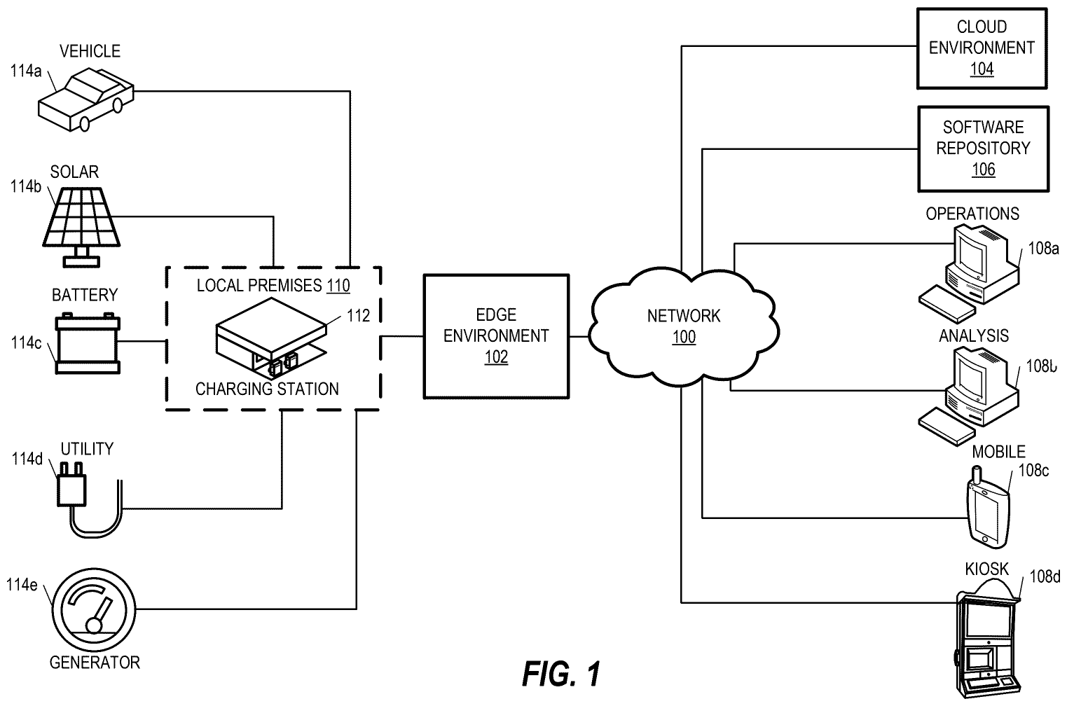

Referring now to the drawings, FIG. 1 depicts a computing environment for managing electric vehicle charging, according to embodiments provided herein. In certain embodiments, managing electric vehicle charging may include controlling EVSEs by issuing one or more commands to the EVSEs (e.g., remotely). As illustrated, the computing environment includes a network 100 that is coupled to an edge environment 102, a cloud environment 104, a software repository 106, as well as one or more ancillary devices 108 (including an operations device 108a, an analysis device 108b, a mobile device 108c, and/or a kiosk device 108d). The network 100 may be configured as any wide area network (WAN, such as the internet, power network, cellular network, etc.) or other network for facilitating communication among the edge environment 102, the cloud environment 104, the software repository 106, and the ancillary devices 108.

The edge environment 102 may generally be deployed at a local premises site 110 (also referred to herein as a site) to provide various services, including coordination and optimization of one or more energy assets 114 (including an EV 114a, a solar device 114b, a battery energy storage system (BESS) 114c, a utility grid 114d, and/or a generator 114e), such as for charging of electric vehicles (e.g., EV 114a) using charging station 112. The charging station 112 may use one or more of various distributed energy resources (DERs), such as the solar device 114b, the BESS 114c, the utility grid 114d, and/or the generator 114e (e.g., an on-site diesel, natural gas, or other type of fueled generator). Generally, the aforementioned DERs may provide energy to the charging station 112 and/or use energy from the charging station 112 (e.g., by way of a backflow of energy from the EV 114a to other aspects of the site 110). In some embodiments, the charging station 112 may send excess energy back to the BESS 114c and/or to the utility grid 114d. Generally, the edge environment 102 may monitor and/or modify the energy sent to and received from the DERs to optimize various tasks, such as the charging of the EV 114a.

The charging station 112 may utilize one or more of various communication protocols, such as open smart charging protocol (OSCP), open charge point interface (OCPI), ISO 15118,OpenADR, open charge point protocol (OCPP), etc. and may represent Level 1, Level 2, Level 3, and higher level charging stations, as applicable. Generally, the “level” of a charging station refers to the power level and/or ability to provide electric power to a device being charged.

The edge environment 102 is configured as an interface between various aspects of the site 110 and the network 100. In various embodiments, compute resources for performing different functions at a site, such as control or optimization of EV charging, may be split between local compute resources in the edge environment 102 and remote compute resources, e.g., in the cloud environment 104 of FIG. 1

The cloud environment 104 is coupled to the edge environment 102 via the network 100 and may be configured for further processing of data, as described herein. While FIG. 1 depicts a single cloud environment 104 that serves a single edge environment 102, this is merely an example, as some embodiments may be configured such that the cloud environment 104 may serve a plurality of edge environments 102 that each serve one or more sites 110, one or more charging stations 112, one or more DERs, and the like.

The software repository 106 is also coupled to the site 110 via the network 100. The software repository 106 may be configured as a platform to program, store, manage, and control changes, etc. to software that is implemented in the edge environment 102 and/or the cloud environment 104. In some embodiments, the software repository 106 may be configured as a proprietary service and/or may be provided by a third-party, such as GitHub™M. Additionally, some embodiments may be configured such that the software repository 106 is provided by the same entity that manages the cloud environment 104. As such, these embodiments may be configured such that the software repository 106 and the cloud environment 104 may be combined.

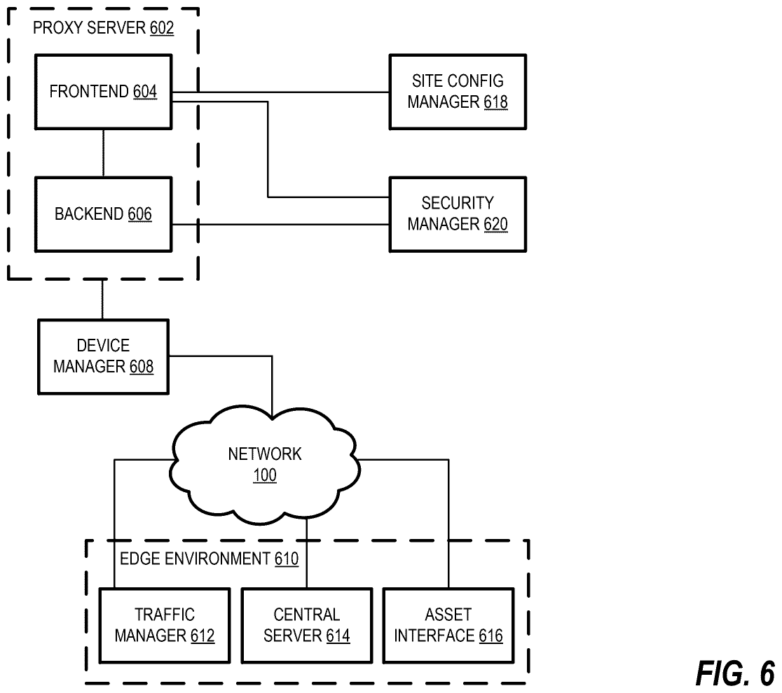

With respect to the ancillary devices 108, the operations device 108a may be utilized to monitor and/or alter operations of the computing environment provided in FIG. 1 The analysis device 108b may analyze utilization, operation, charging, and/or other features of the computing environment provided in FIG. 1 The mobile device 108c may represent an administrator device and/or a user device. As a user device, the mobile device 108c may initiate charging, perform payment, and/or perform other user-specific actions. As an administrator device, the mobile device 108c may perform administrative operations, analysis, and/or other actions. The kiosk device 108d may be located at one of the charging stations 112 and/or remote therefrom and may provide user-specific or administrative actions, similar to that of the mobile device 108c. In some embodiments, one or more administrators may use the kiosk device 108d to view information about a site or make changes. As will be understood by one of ordinary skill in the art, the ancillary devices 108 may each include one or more processors, one or more memory components, and/or other hardware and/or software for performing the functionalities provided herein. It should be understood that while the kiosk device 108d is depicted as being remote from the site 110, some embodiments may not be configured in this manner. Specifically, some embodiments may utilize a kiosk device 108d that is local at the site 110, which may communicate via a local network and/or the network 100 for providing the services described herein. Moreover, in certain embodiments, the mobile device 108c and/or the kiosk device 108d may provide a user interface for issuing remote commands to EVSEs, described herein with reference to, for example, FIGS. 6 and 9-12

### Example Edge Environment

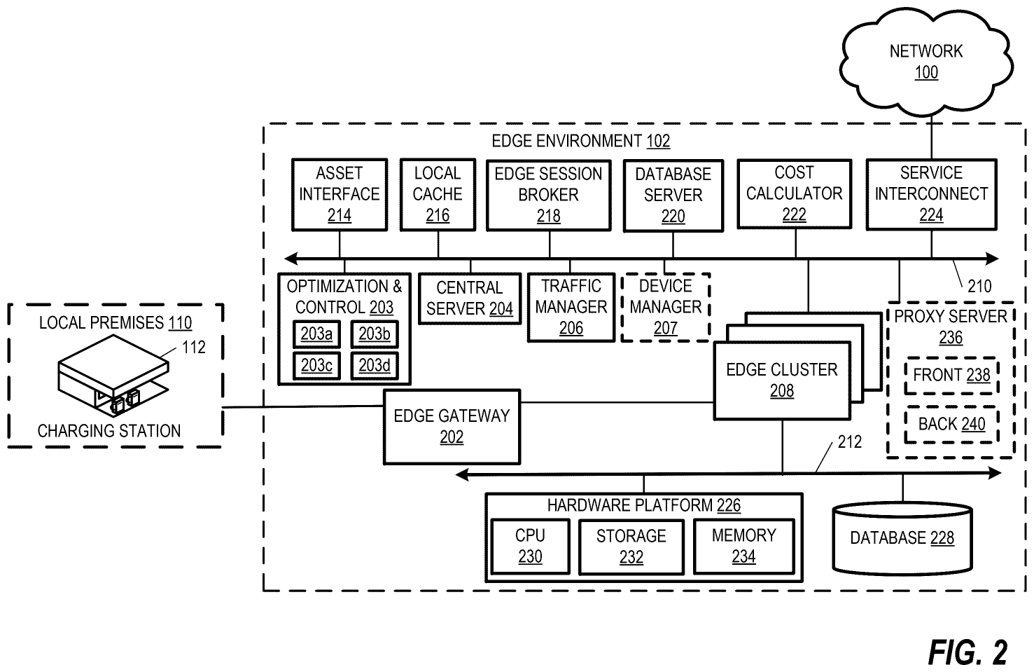

Referring now to FIG. 2 the edge environment 102 may be coupled to the site 110 via an edge gateway 202. The edge environment 102 may be operatively coupled to various aspects of the site 110, such as the charging station 112 via the edge gateway 202. The edge environment 102 further includes an edge cluster 208, which is coupled to communication bus 210 and hardware bus 212. The communication bus 210 is coupled to optimization and control manager 203, asset interface 214, local cache 216, edge session broker 218, database server 220, cost calculator 222, and service interconnect 224 in this example. Moreover, the communication bus 210 is coupled to central server 204 and traffic manager 206. In some embodiments, the communication bus 210 may be coupled to device manager 207 as well as proxy server 236, which may include frontend component 238 and backend component 240. The hardware bus 212 is coupled to hardware platform 226, which may include one or more processors, such as CPU 230, one or more storage components 232, one or more memory components 234, and/or other hardware components. Also coupled to the hardware bus 212 is database 228. Though certain components (e.g., cost calculator 222, database server 220, etc.) of edge environment 102 are depicted separate from hardware platform 226, they may be services or processes configured to run on hardware platform 226. Further, though certain components are illustrated as separate components, the functionality of such components may be combined into a single component and/or further divided among additional components.

The communication bus 210 and the hardware bus 212 may be utilized to facilitate operation of all services that run in the edge environment 102 and communicate with each other via a distributed message streaming system. The coupling of the aforementioned services may be accomplished in some embodiments via a distributed message streaming system, such as NATS.

In the depicted example, the charging station 112 is configured for communication with the edge environment 102 via the edge gateway 202, such as via a short-range wireless network technology, such as via a ZigBee® PAN. The edge gateway 202 may be configured to receive data, such as electric vehicle charging data, price change data, vehicle data, etc. from the charging station 112 and/or vehicles that are being charged via the connection with the site 110 (of FIG. 1).

In some embodiments, the edge gateway 202 may be configured to abstract data received from various aspects of the site 110 (of FIG. 1), such as the charging station 112, to remove protocol-specific distinctions. For example, a first charging station may utilize a first communication protocol and/or billing protocol and a second charging station may utilize a second communication protocol and/or billing protocol. The edge gateway 202 may receive data packets from both the first charging station using the first communication protocol and the second charging station using the second communication protocol. The edge gateway 202 may transform the received data into a protocol-agnostic format prior to providing the data to the edge cluster 208. This may allow wide interoperability between the edge environment 102 and various types of hardware (e.g., the charging station 112) at a site. To this end, in certain embodiments, the edge gateway 202 may cooperate with the device manager 207 and/or the proxy server 236 to perform, at least in part, one or more of the functionalities performed by, for example, device manager 608 (corresponding to the device manager 207 of FIG. 2) and/or proxy server 602 (corresponding to the proxy server 236 of FIG. 2) shown in and described herein with reference to FIG. 6 For example, these functionalities may include issuing remote commands for EVSEs. Accordingly, while the edge gateway 202, the device manager 207, and the proxy server 236 are illustrated as separate modules in FIG. 2 they may be implemented as a combined module or service in some embodiments. Additional details and example functionality of the device manager 207 and the proxy server 236 (including frontend component 238 and backend component 240) are described further herein, for example, with reference to the device manager 608 and the proxy server 602 (including frontend component 604 and backend component 606) of FIG. 6

The edge cluster 208 is the central message center in various embodiments. For example, when a user plugs a vehicle into the charging station 112, the edge cluster 208 receives data from the edge gateway 202, parses that data (e.g., to generate access state data) and causes the state data to be sent to the database server 220. The edge cluster 208 also receives the data and creates a session entry, which may be stored in the local cache 216. The edge cluster 208 may additionally send the session entry to the cloud environment 104 (of FIG. 1) via the network 100. The edge session broker 218 may also receive data related to the new session and may query the database server 220 to access additional session data to determine charging characteristics for the charging station 112.

The edge session broker 218 may produce data or signals that are sent to the edge cluster 208, which may be sent to the edge gateway 202 for potentially sending back to one or more of the charging stations 112. Information that may be reported might include current delivered over time (e.g., amperes), total energy delivered (e.g., kWh), power delivered over time (e.g., kW), voltage at the charging station over time (e.g., V), charging station state (e.g., connected, disconnected, offline), connectivity state, charging state, etc. The charging stations 112 may report any errors back to the edge cluster 208. The cost calculator 222 may be engaged to access pricing data from the cloud environment 104 and may calculate costs incurred based on delivered energy, expected costs prior to charging, idle time interval, parking time interval, etc. The asset interface 214 may be a software interface between the edge environment 102 and the energy assets 114, and correspond to asset interface 616 of FIG. 6

The edge cluster 208 may be configured such that any message received by the edge cluster 208 may also be sent to the cloud environment 104 (of FIG. 1) for consumption by a data subscriber in the cloud environment 104. For example, if a user of the mobile device 108c (in FIG. 1) desires to claim a charging session, the mobile device 108c does not need to access the edge environment 102 directly. Instead, the mobile device 108c may connect with the cloud environment 104 (of FIG. 1), which sends a message to the edge cluster 208 with an instruction to claim the session. The service interconnect 224 is configured for establishing an HTTP, TCP, and/or other type of communication with the cloud environment 104 (of FIG. 1) via the network 100.

The central server 204 may provide a centralized management system for one or more services related to various energy assets 114 at the site 110 (of FIG. 1), including, for example, various charging services associated with the charging station 112 (of FIG. 1) and/or other EVSEs at the site 110. For example, the central server 204 may be engaged to onboard a new EVSE at the site 110, control various functionalities of the EVSEs at the site 110 such as, for example, starting, stopping, or resetting of the EVSEs.

The traffic manager 206 may be used to monitor and/or manage charging sessions associated with various EVSEs (e.g., including the charging station 112) at the site 110. In that regard, the traffic manager 206 may cooperate with the edge session broker 218 for determining a state of an EVSE (e.g., whether the EVSE is started, stopped, or reset, whether there is any active charging session, etc.).

The optimization and control manager 203 may provide energy optimization and adaptive load management (ALM) functions, for example, for various energy assets 114 at the site 110 (of FIG. 1). For example, the optimization and control manager 203 may be responsible for calculating set-points for each asset for the energy optimization and ALM amongst the energy assets 114 and providing data related to the calculated set-points to the asset interface 214. In certain embodiments, the optimization and control manager 203 may include a database layer 203a to store data related to site configurations, an orchestration layer 203b to gather data and trigger optimizations, an optimization layer 203c to calculate set-points, and a control layer 203d for higher frequency feedback based controls. In some embodiments, the functionalities of the optimization and control manager 203 may be implemented, at least in part, within the cloud environment 104 (of FIG. 1).

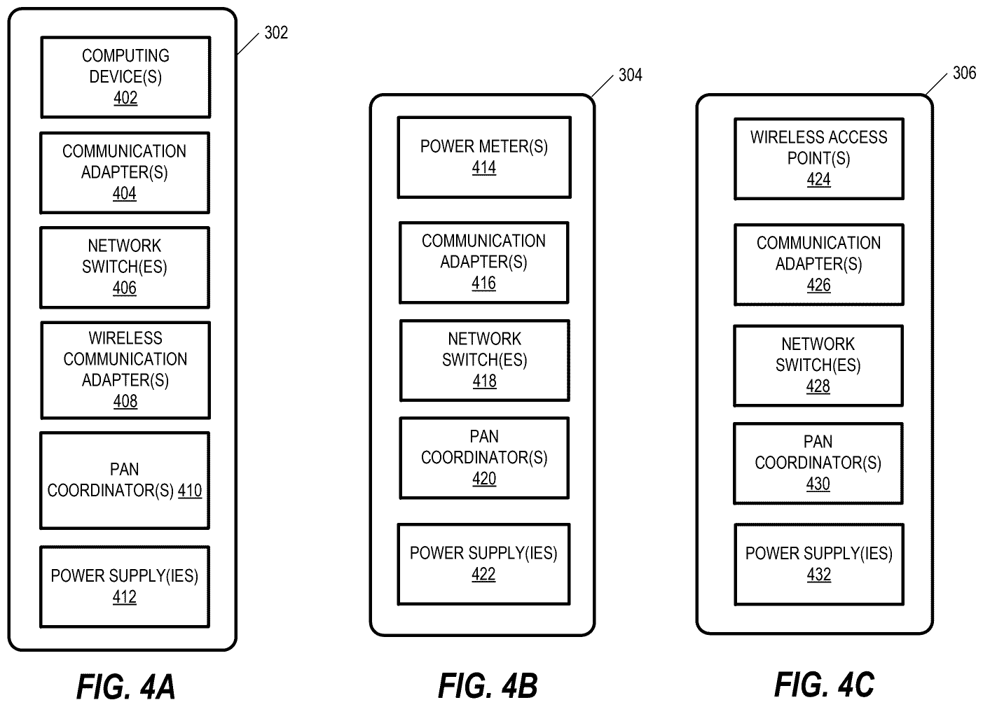

The hardware platform 226 represents any hardware for facilitating the processes and actions described herein. Specifically, the one or more CPUs 230 may represent one or more types of processing device configured for executing instructions. The one or more storage components 232 may be configured as long term storage, such as a hard drive or the like. The one or more memory components 234 may include any of various types of read or access memory or the like. The one or more databases 228 may be configured for additional storage and may be housed with the other hardware and/or elsewhere. Examples of different hardware platforms that may be deployed in the edge environment 102 are described further below with respect to FIGS. 4A-4C.

### Hardware Configurations for Edge Environment

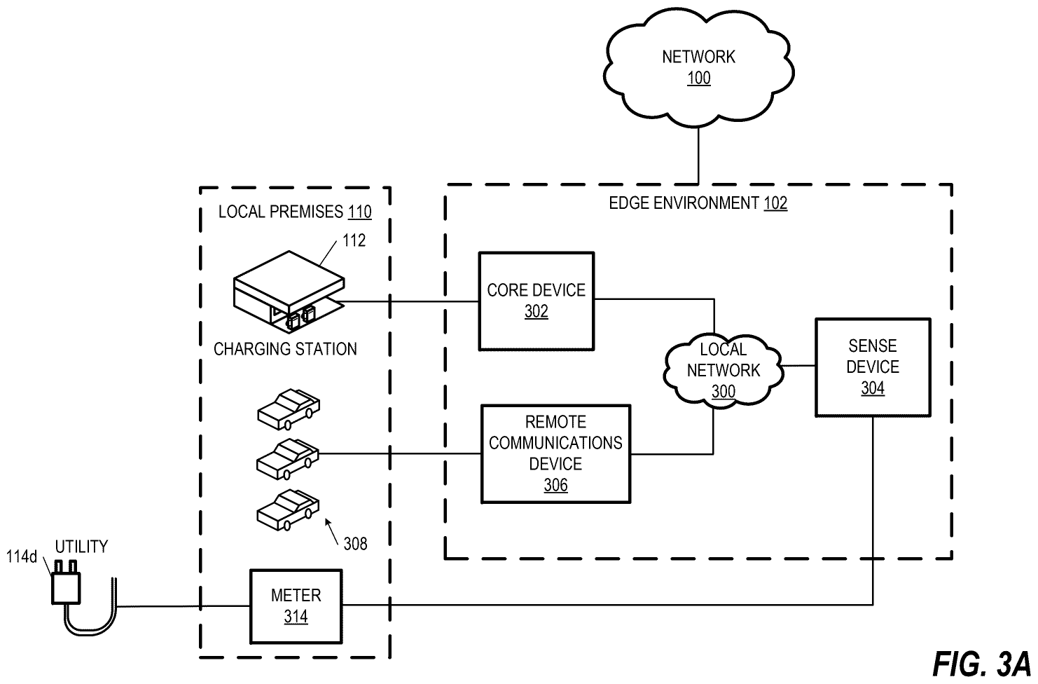

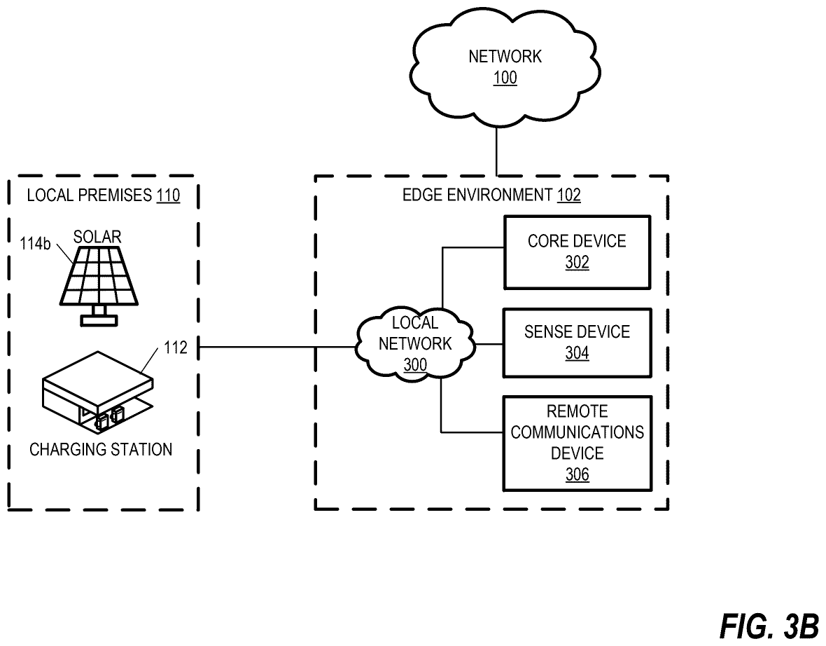

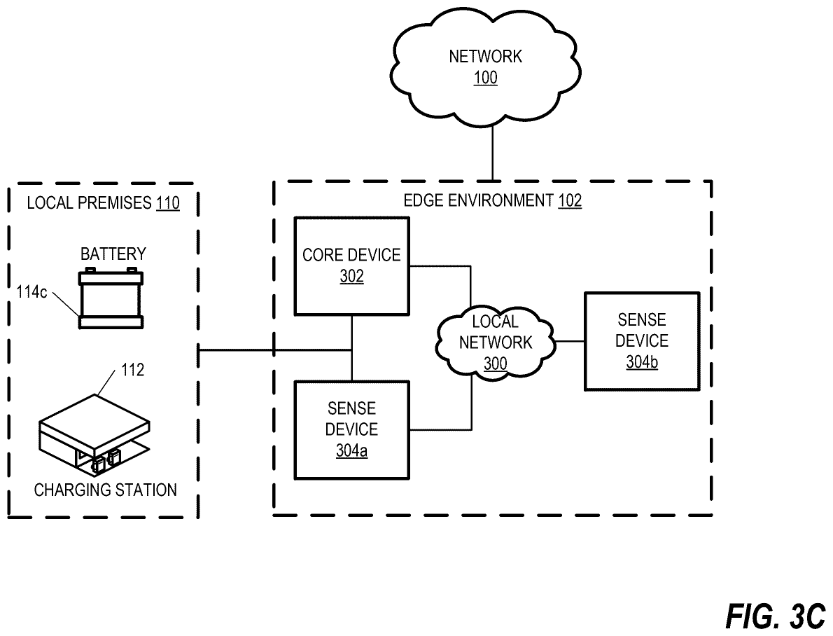

FIGS. 3A-3C depict device configurations for edge environment for managing electric vehicle charging, according to embodiments provided herein. In certain embodiments, managing electric vehicle charging may include controlling a plurality of EVSEs, for example, by issuing one or more commands to the EVSEs (e.g., remotely). FIG. 3A depicts a charging solution. As illustrated, the charging station 112 is coupled to a local network 300 via a core device 302. The local network 300 may include any local area network, Ethernet, PAN, etc. The core device 302 may be physically installed within communications range of the one or more chargers in the charging station 112. A sense device 304 may be installed, for example, in an electrical room or in another enclosure with electrical equipment of the charging station 112 and/or the one or more energy assets 114 to monitor the main metering point for the local utility point of common coupling. This may enable one or more algorithms to provide the optimal dispatch of EV charging power, subject to local energy rates and the vehicles currently charging. In the case that there are vehicles 308 using EV chargers that are out of communications range of the core device 302, such as at a sub-level of a parking garage, one or more remote communications devices 306 are included as required. Also included at the site 110 is a meter 314 for communicating energy with the utility grid 114d.

The core device 302 shown in FIG. 3A is the central processing device and serves as the communications hub. In certain embodiments, the components of FIG. 2 may generally operate, at least in part, as part of the core device 302. The core device 302 may provide optimization, load management, communication coordination, and/or data historian services. The core device 302 may communicate with the cloud environment 104 via cellular modem, wired internet service provider (ISP), and/or other communications medium to get current optimization and load management set points for the charging stations 112 and/or other assets, such as via an optimization algorithm that may be stored locally and/or at the cloud environment 104. It will be understood, however, that some embodiments may be configured such that the core device 302 performs optimization locally. In certain embodiments, the core device 302 dispatches these set points through a local communications protocol (e.g., Wi-Fi) and/or via the remote communications device 306 to reach locations that are distant or hard to reach, such as charging stations with a core device 302 and/or sense device 304 at sub-levels of a parking garage or a rooftop solar inverter. The core device 302 may additionally or alternatively collect data directly from distributed energy resources and power measurement devices or through cloud-based communications with the network 100.

Power and energy metering data may be collected via the sense device 304. The sense device 304 may include a smart meter with support for multiple single-and three-phase loads, such as with a local historian and Ethernet communication back to the device via the local network 300. The sense device 304 may also incorporate support for additional devices running on the edge including but not limited to thermocouple wiring, weather stations, temperature sensors, pyranometers, etc. It should be noted that additional sense devices 304 and remote communication devices 306 can be added to handle a variety of situations, such as a separate subpanel for energy metering of a new solar system or for monitoring of a new inverter associated with a rooftop solar installation.

FIG. 3B depicts a solar application where the core device 302 and the sense device 304 are installed in an electrical room or other common area. The sense device 304 can monitor the main metering point for the local utility as well as the solar production at tie-in breakers for the solar device 114b. The remote communications device 306 may be installed in a position to communicate directly with the solar device 114b and report the data received from the solar device 114b to the core device 302. Accordingly, the core device 302, the sense device 304, and the remote communications device 306 depicted in FIG. 3B may perform similar functions as those devices depicted in FIG. 3A.

FIG. 3C depicts a battery application where the core device 302 and the sense device 304 (including a first sense device 304a and a second sense device 304b) are installed physically near the BESS 114c. In some cases where the BESS 114c is near the point of common coupling with the utility grid 114d, a single sense device 304a can monitor the full site. In some cases where there is a significant distance to the metering point for the utility grid 114d, the second sense device 304b (or a plurality of second sense devices 304b) may be installed near the utility meter, such as the electrical room.

### Hardware Components in Core, Sense, and Remote Communications Devices

FIGS. 4A-4C depict hardware that may be utilized for the devices from FIGS. 3A-3C, according to embodiments provided herein. Specifically, FIG. 4A depicts hardware components that may be present in the core device 302. In some embodiments, the core device 302 is the brain where the energy optimization and adaptive load management (ALM) functions (e.g., by the optimization and control manager 203 of FIG. 2) are executed and dispatched. As illustrated, the core device 302 may include one or more computing devices 402, one or more communication adapters 404, one or more network switches 406, one or more wireless communication adapters 408, one or more PAN coordinators 410, and/or one or more power supplies 412. As will be understood, the computing device(s) 402 may include one or more processors, one or more memories, and/or other components that a conventional, specific-purpose machine may utilize. In some embodiments, the computing device(s) 402 may include power line communication (PLC) infrastructure, while some embodiments may utilize retail and/or micro-industrial computer components for optimization, load management, communication coordination, and/or historian services.

The communication adapter(s) 404 may be configured for load balancing and otherwise managing communications of, for example, Modubus RTU (RS485) to Modbus TCP (ethernet) or Ethernet IP (RJ45) to Ethernet Optical (SFP), etc. The network switch(es) 406 may be configured for routing of network traffic, and may be configured as an Ethernet switch for communication to other nodes (e.g., the sense device 304, the remote communications device 306, and/or other core device 302), distributed energy resources, and/or energy based management systems.

The wireless communication adapter(s) 408 may include a cellular modem, internet modem, Wi-Fi access point, etc. for facilitating wireless communications to the internet or other wide area network. Similarly, the PAN coordinator(s) 410 may be configured to create and/or join communication connections with other devices. This may include a ZigBee coordinator, Bluetooth device, and/or other device for performing this function. The power supply(ies) 412 may be configured as battery power, connection to external power, etc.

FIG. 4B depicts hardware components of the sense device 304 from FIGS. 3A-3C. The sense device 304 may be configured as a smart-metering piece for collection and storage of power/energy data such as measurements such as temperature, voltage, current, power, solar irradiance, wind speed, etc. The sense device 304 may include a smart meter with multiple channels of measurement that may comprise single-phase circuits and/or three-phase circuits. The sense device 304 may communicate meter data back to the core device 302 from meter locations such as electrical rooms, rooftop solar installations, EV chargers, and subpanels. Certain embodiments may be optimized for ease of installation and reduced intrusion to the site. Power over Ethernet (POE) sourced from the core device 302 may suffice for most installations. The sense device 304 may transmit data back to the core device 302 via a network switch. The sense device 304 may be optimized to utilize minimal power, and PoE may be acceptable for most installations.

As illustrated in FIG. 4B, the sense device 304 includes one or more power meters 414, one or more communication adapters 416, one or more network switches 418, one or more PAN coordinators 420, and/or one or more power supplies 422. The power supply(ies) 422 may include a power interface for providing power to the sense device 304. The power meter(s) 414 may be utilized for monitoring single-phase and three-phase loads of power. The communication adapter(s) 416 may be utilized for facilitating communications between the sense device 304 and other devices. The network switch(es) 418 may be a PoE enabled switch for communication. Similarly, the PAN coordinator(s) 420 may create and/or join personal area networks, such as via ZigBee, Bluetooth, and the like. In some embodiments, PoE or other power source may be utilized.

As illustrated in FIG. 4C, the remote communications device 306 is a network-connectivity extension, primarily for EV charging or solar monitoring locations where ZigBee, Wi-Fi, or Ethernet is being extended to remote or difficult-to-reach locations such as remote subpanels, parking garage levels, or rooftop inverters. Some embodiments are optimized for ease of installation and reduced intrusion to the site where PoE may suffice for most installations from the core device 302. The remote communications device 306 may be configured to transmit data back to the core device 302 via a network switch.

Specifically, the remote communications device 306 may include one or more wireless access points 424, one or more communication adapters 426, one or more network switches 428, one or more PAN coordinators 430, and/or one or more power supplies 432. The wireless access point(s) 424 may be configured to extend wireless communication signals to chargers and/or other intelligent electronic devices. The communication adapter(s) 426 may be configured for facilitating communications between the remote communications device 306 and other devices. The network switch(es) 428 may be configured as a POE Ethernet switch and/or other network switch for communicating with the core device 302. The PAN coordinator(s) 430 may be configured to create and/or join personal area networks, such as via ZigBee, Bluetooth, and the like. The power supply(ies) 432 may include a power interface for providing power to the remote communications device 306.

### Example Cloud Environment

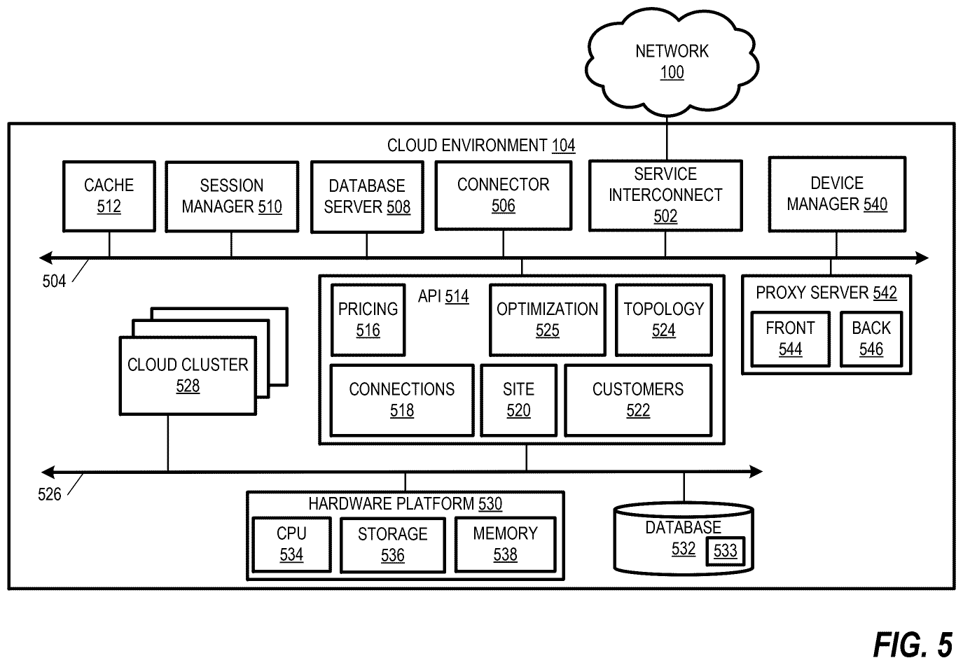

FIG. 5 depicts a device configuration for a cloud environment for managing electric vehicle charging, according to embodiments provided herein. In certain embodiments, managing electric vehicle charging may include controlling a plurality of EVSEs, for example, by issuing one or more commands to the EVSEs (e.g., remotely). As illustrated, the network 100 may couple to the cloud environment 104 via a service interconnect 502 that corresponds with the service interconnect 224 from FIG. 2 Similar to the service interconnect 224 from FIG. 2 the service interconnect 502 may be configured to facilitate an HTTP, TCP, and/or other communication portal through the network 100 to the edge environment 102 for the exchange of data between the edge environment 102 and the cloud environment 104. Additionally or alternatively, the service interconnect 502 may be configured to facilitate an HTTP, TCP, and/or other communication portal through the network 100 directly with an EVSE, such as charging station 112, for the exchange of data between the cloud environment 104 and the EVSE. For example, in some such embodiments, cloud environment 104 may be configured with the same or similar components as edge environment 102 (e.g., in addition or alternative to one or more components shown in FIG. 5) and configured to perform functions similar to edge environment 102, such that a separate edge environment 102 may not be needed.

The service interconnect 502 is coupled to a communication bus 504, which facilitates communication among various components of FIG. 5. Also connected to the communication bus 504 are a NATS connector 506, a database server 508, a session manager 510, a cache 512, a device manager 540, a proxy server 542 (e.g., including a frontend component 544 and a backend component 546), and a collection of services and application programming interfaces (APIs) 514. The APIs 514 may include a pricing API 516, a connections API 518, a site API 520, a customers API 522, a topology API 524, and/or an optimization API 525. The APIs 514 may be implemented by the hardware platform 530. A hardware bus 526 is coupled to a NATS cloud cluster 528, as well as the hardware platform 530 and a database 532. The hardware platform 530 may include one or more CPUs 534, one or more storage components 536, and one or more memory components 538. Though certain components of cloud environment 104 are depicted separate from hardware platform 530, they may be services or processes configured to run on hardware platform 530. Further, though certain components are illustrated as separate components, the functionality of such components may be combined into a single component and/or further divided among additional components.

The APIs 514 is a component of the cloud environment 104. As such, the APIs 514 (including the pricing API 516, the connections API 518, the site API 520, the customers API 522, the topology API 524, and/or the optimization API 525) may cause storage of and/or process site information, site topology, customers, connections to panels, constraints of panels, pricing information of each site, local forecasting services, optimization services, controller services, caching services, etc. The APIs 514 may also serve as a mobile backend by storing personal information of charge users (e.g., email, charging preferences, payment preferences, privileges, access, fleet information, etc.). The APIs 514 may additionally store peak charging configurations, data related to meter setup, etc. In some cases, the APIs 514 may also be responsible for tracking changes to EVSE connections and causing related changes to various types of data. For example, a newly connecting EVSE may create a new charging session, and a newly disconnecting EVSE may close a charging session. The connection and the disconnection may cause changes in payment information for user(s) of the connecting or disconnecting EVSE(s), for example, related to payment for energy usage. In some embodiments, the pricing API 516 may be used for storing information related to pricing configuration of a charging site, such as the site 110 (of FIG. 1). Some examples of the information related to pricing configuration of a charging site may include, but not be limited to, cost for energy (e.g., $/kWh), cost for parking time (e.g., $/time-interval), cost for idle parking time (e.g., $/idle-time-interval), etc. In certain embodiments, the site API 520 may be or include a service that provides an A PI to read or change information about a charging site (e.g., site name, address, etc.). The topology API 524 may be used for storing information related to topology of EVSEs, and may be utilized to track, for example, which EVSEs are connected to which electrical panels and whether any electrical panels may be subpanels of other panels. Such information may be utilized for load management. In some embodiments, the optimization API 525 may be responsible for handling optimization requests, performing one or more optimization methods, and communicating the result of the optimization. For example, the optimization API 525 may be or include a service that may be executed when there is a newly connected or disconnected EVSE, such that an optimization may be performed to allocate (e.g., re-allocate) power according to updated state(s) of the EVSE(s).

When a vehicle is plugged into a charging station 112 (FIG. 1), the edge session broker 218 (FIG. 2) may communicate connection information to the APIs 514. The connection information may include vehicle information, user information, charging station information, etc. The APIs 514 then create a charge session object, which is stored in the cache 512. The cache 512 sends the session data, along with topology constraints and the charge session object to the edge environment 102. The NATS connector 506 may additionally cause the NATS cloud cluster 528 to maintain the charge session object for retrieval by an interested party. As the session continues, the session manager 510 may be utilized to alter constraints of the session, which may cause the NATS cloud cluster 528 to update the charge session object.

When a user claims a previously created session with the mobile device 108c, the database server 508 may create a database entry (e.g., within the database 532) with the charge session, driver, energy request, willingness to pay, electricity purchased, etc. The NATS connector 506 may update the NATS cloud cluster 528 with the database entry. This data may then be sent to the edge environment 102. When the charge session ends (e.g., when the vehicle is unplugged), that action may be added to the database entry and the database entry may be moved from a current sessions list to a completed sessions list.

In certain embodiments, the database 532 may include optimization data 533 related to, for example, optimization scenarios (e.g., past optimization scenarios which may be used for debugging and/or auditing the performance of a given optimization scheme).

As indicated above, the hardware platform 530 may represent hardware that may be utilized to execute the components described regarding FIG. 5. As such, the CPU(s) 534 may be configured as any processing unit for receiving and executing computer-readable instructions. The storage component(s) 536 may be configured as any hard drive or other local storage device. The memory component(s) 538 may be configured as any type of RAM, ROM, registers, etc. or the like.

Moreover, as described further herein, the device manager 540 and the proxy server 542, including the frontend component 544 and the backend component 546, may perform the techniques for issuing remote commands for EVSEs, such as described herein with reference to FIG. 6

### Device Configuration for Proxy Service System

FIG. 6 depicts a device configuration for a system for issuing remote commands for EVSEs, according to embodiments provided herein. As depicted, the system of FIG. 6 includes a proxy server 602. The proxy server 602 may include a frontend component 604 and a backend component 606, and may be coupled to device manager 608. The frontend component 604 may be in data communication with site configuration manager 618 and security manager 620. The backend component 606 may be in data communication with the security manager 620. The device manager 608 may be coupled to network 100 to communicate with one or more components disposed within edge environment 610. The edge environment 610 may correspond to the edge environment 102 of FIG. 2 and include a plurality of components such as, for example, traffic manager 612, central server 614, and asset interface 616 that perform various functionalities described herein with reference to various components of the edge environment 102 shown in FIG. 2

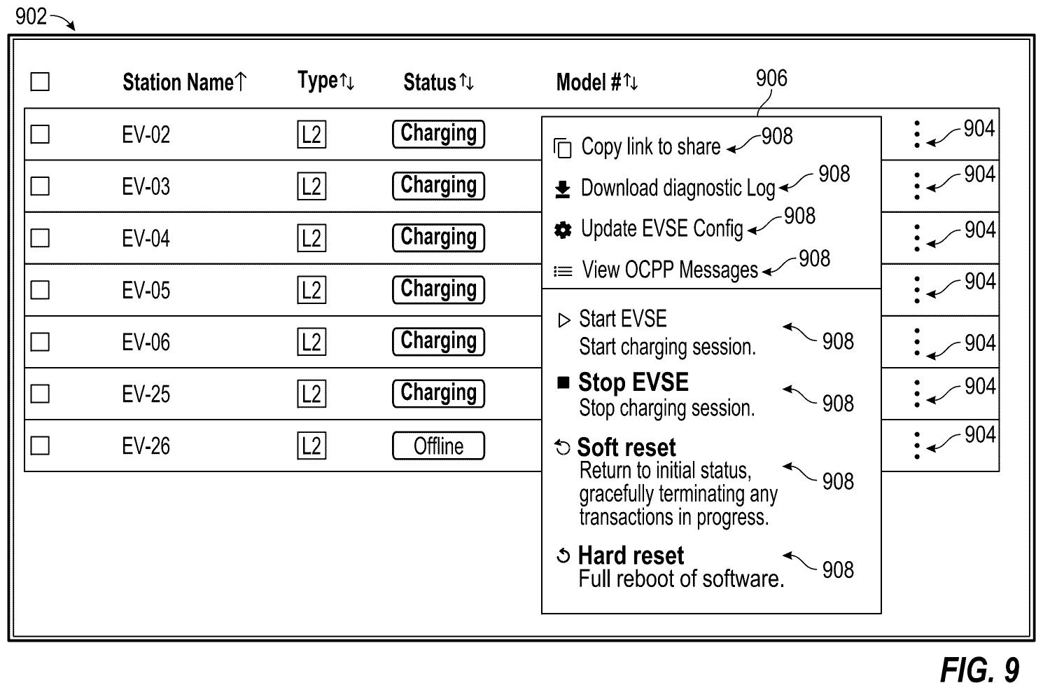

In some embodiments, the proxy server 602 may include one or more processors, one or more memory components, and/or other hardware and/or software for performing the functionalities described herein. The frontend component 604 may implement an administrator-or operator-facing user interface, for example, for receiving input related to controlling one or more EVSEs. In certain embodiments, the user interface may be a graphical user interface, such as those described herein with reference to FIGS. 9-12 for displaying a plurality of user interface elements, at least some of which may be configured to receive user input for controlling one or more EVSEs. As depicted, the frontend component 604 may be in data communication with the site configuration manager 618 for receiving information related to the one or more EVSEs to be controlled by the user interface. For example, the site configuration manager 618 may provide, to the frontend component 604, data related to, for example, communication protocols supported by the EVSEs, identifying information of the EVSEs, etc. To this end, in certain embodiments, the site configuration manager 618 may include a storage device or a memory configured to store the data related to the EVSEs, and may be in data communication with, for example, the edge environment 610 for receiving or retrieving the data related to the EVSEs. A user accessing the user interface provided by the proxy server 602 (e.g., via the frontend component 604) may be authenticated in order to access the user interface. For example, the user may provide a user credential such as, for example, a user name and a password on the user interface to gain access, for example, for issuing remote commands to EVSEs. Other secure methods of accessing the user interface may also be possible.

In some embodiments, additional security data (e.g., a token) may be received by the frontend component 604 from the security manager 620 (e.g., a token service server) for issuing remote commands to EVSEs. For example, the user credential used to access the user interface may be processed to retrieve the security data from the security manager 620 for, for example, issuing remote commands to EVSEs. The security manager 620 may be implemented within a secure environment without direct access to any user, and the frontend component 604 may retrieve the security data based on the user being authenticated. In certain embodiments, a permitted level of access may be determined based on the authentication of the user. For example, the permitted level of access may be based on a role assigned to the user (e.g., an administrator or an operator with different sets of commands being allowed to be issued respectively thereby) and/or one or more sites that the user is given access for (e.g., one or more charging sites), determined based on the authentication of the user.

The frontend component 604 may generate and activate a plurality of user interface elements to be provided as part of the user interface for issuing remote commands to EVSEs. For example, various user interface elements may be generated for selecting one or more EVSEs, as well as for selecting one or more command types for commands to be sent to the one or more EVSEs. The generation and/or the activation of the plurality of user interface elements may be based on the permitted level of access for a user that has been authenticated. For example, the frontend component 604 may provide, on a user interface, only the user interface elements corresponding to one or more EVSEs and one or more command types that a user has access to based on the authentication of the user. For example, a user that has access to control an EVSE at a particular site may be provided with one or more user interface elements associated with controlling the EVSE at this site. The provided user interface elements may not include any element corresponding to an EVSE or a site that the user does not have access to. Moreover, in certain embodiments, some of the user interface elements that are provided (e.g., displayed on the user interface) may not be activated (e.g., for input or selection by the user) if, for example, a command type associated with such user interface element(s) cannot be sent to the corresponding EVSE. For example, if the EVSE is not in a state to be issued a certain command (e.g., when the EVSE is in a stopped state and cannot be issued a stop command), the user interface element(s) associated with such command for the EVSE may be deactivated, and may not be available for the user to select. In certain embodiments, if multiple EVSEs are selected by the user for sending a bulk command of a given command type, and if the command of the given command type cannot be sent to all of the selected EVSEs (e.g., based on a permitted level of user access, a current state of an EVSE, etc.), the user interface element associated with issuing the bulk command of the given command type may be disabled.

The backend component 606 may provide a software interface between the frontend component 604 and the device manager 608 and/or the edge environment 610. For example, the backend component 606 may be utilized to retrieve EVSE and other related information (e.g., available EVSE information, including identifying information, type or model information, state information such as charging state information, etc., as well as available command type information, etc.) from, for example, the edge environment 610. The retrieved information may be used to generate various user interface elements to be provided on a user interface by the frontend component 604.

Moreover, the backend component 606 may receive an instruction from the frontend component 604 regarding one or more remote commands to be issued to EVSEs. For example, the frontend component 604 may provide, to the backend component 606, data including, for example, a command type for remote commands to be sent to EVSEs, identifying information of the EVSEs such as, for example, Chargebox Identities (CBIDs) of the EVSEs, security data such as, for example, the token retrieved by the frontend component 604 from the security manager 620, etc. As such data is received by the backend component 606, the backend component 606 may determine whether the instructed remote commands may be sent to the EVSEs (e.g., by communicating with, for example, the security manager 620). If the remote commands are allowed (e.g., based on the received token being verified by the security manager 620) to be sent to the EVSEs, the backend component 606 may provide, to the device manager 608, data including, for example, the command type for the remote commands to be issued to the EVSEs, the identifying information of the EVSEs to issue the remote commands to, etc.

When the data including the command type of remote commands to be issued, the identifying information of the EVSEs to issue the remote commands to, etc. is received at the device manager 608, the device manager 608 may utilize the received data to generate the commands to send to the EVSEs, and send the commands to the edge environment 610 via the network 100, such that the commands may be propagated to the EVSEs via various components within the edge environment 610, such as the asset interface 616. In certain embodiments, the remote commands may be generated based on a particular communication protocol that a target EVSE supports. For example, if the target EVSE supports OCPP, the device manager 608 may generate the corresponding OCPP message(s) to send to the target EVSE for causing an action associated with a selected command type. If the target EVSE supports another protocol such as, for example, a manufacturer-specific communication protocol, the device manager 608 may generate command(s) including message(s) to cause an action associated with the selected command type. To this end, the device manager 608 may dynamically generate the appropriate commands to send to the EVSEs, where the actual commands may be different for different EVSEs while being of a same command type (e.g., when sending a particular command type to multiple EVSEs in bulk).

In certain embodiments, the proxy server 602 and the device manager 608, while illustrated as separate modules in FIG. 6, may be implemented as a combined module. Moreover, while the proxy server 602 and the device manager 608 are illustrated in FIG. 6 as being outside of the edge environment 610 (e.g., residing within a cloud environment such as the cloud environment 104 described herein with reference to, for example, FIG. 5), the proxy server 602 and/or the device manager 608 may be implemented within the edge environment 610 in certain embodiments. For example, the proxy server 602 and/or the device manager 608 may be implemented as, respectively, the proxy server 236 and/or the device manager 207 described herein with reference to FIG. 2 and may be in data communication with a plurality of EVSEs at a customer site via a LAN or PAN. Moreover, in certain embodiments, the frontend component 604 and the backend component 606 may each be one or more software processes that run on the hardware, for example, of the proxy server 602 or elsewhere. Alternatively, the frontend component 604 and the backend component 606 may be part of a combined process that performs the functionalities of both the frontend component 604 and the backend component 606. Other combinations of the processes and functionalities as would be apparent to one of ordinary skill in the art may also be possible with respect to the frontend component 604 and the backend component 606, and/or any other components discussed herein, such as the device manager 608.

### Internal Architecture and Logic for Frontend and Backend Components of Proxy Server

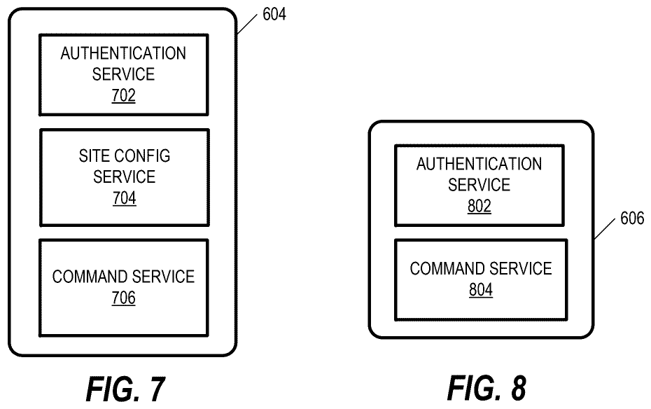

FIG. 7 depicts internal architecture and logic included within the frontend component 604 for issuing remote commands for EVSEs, according to embodiments provided herein. As described herein, the frontend component 604 may be implemented as part of the proxy server 602 of FIG. 6 for issuing remote commands for EVSEs. A s depicted, the frontend component 604 may include authentication service module 702, site configuration service module 704, and command service module 706.

The authentication service module 702 may determine whether a user attempting to access the user interface, described herein for issuing remote commands to EVSEs, may access the user interface. For example, the authentication service module 702 may determine whether a user credential such as a username-and-password combination is acceptable to allow access to the user interface. Moreover, the authentication service module 702 may retrieve security data to be utilized for issuing a remote command (e.g., a token from security manager 620 described herein with reference to FIG. 6).

The site configuration service module 704 may determine information regarding various EVSE(s) that are located at one or more sites, including identifying information, state information, supported communication protocol information, and the like of the EVSEs, as described herein. The collected information may be used to provide the corresponding information (e.g., the identifying information, the state information, and the supported communication protocol information of the EVSEs) on a user interface, for example, via a plurality of user interface elements.

The command service module 706 may receive (e.g., via a user interface) information regarding a command type of remote commands to be issued to EVSEs, as well as identifying information of the EVSEs to issue the remote commands to. The command service module 706 may then provide an instruction, to the backend component 606 (of FIG. 6), including the command type of remote commands to be issued to EVSEs and the identifying information of the EVSEs to issue the remote commands to.

FIG. 8 depicts internal architecture and logic included within the backend component 606 for issuing remote commands for EVSEs, according to embodiments provided herein. As described herein, the backend component 606 may be implemented as part of the proxy server 602 of FIG. 6 for issuing remote commands for EVSEs. As depicted, the backend component 606 may include authentication service module 802 and command service module 804.

The authentication service module 802 may determine whether a command of a selected command type may be sent to an EVSE. For example, the authentication service module 802 may communicate with the security manager 620 of FIG. 6 to verify a token provided for sending the command of the selected command type to the EVSE.

The command service module 806 may receive information regarding a command type of remote commands to be issued to EVSEs, as well as, for example, identifying information of the EVSEs to issue the remote commands to. The command service module 806 may then provide an instruction, to the device manager 608 (of FIG. 6), including the command type of remote commands to be issued to EVSEs, the identifying information of the EVSEs to issue the remote commands to, etc. such that the device manager 608 may generate the appropriate commands to the EVSEs (e.g., including one or more parameters based on the received identifying information of the EVSEs, etc.) based on such instruction.

### Graphical User Interfaces for Issuing Remote Commands for EVSEs

FIG. 9 depicts an example graphical user interface for issuing remote commands for EVSEs, according to embodiments provided herein. As depicted, the user interface 902 includes a plurality of fields and user interface elements. Some examples of the information that may be included in these fields and user interface elements may include, but not be limited to, EVSE identifier, EVSE type, EVSE model, EVSE status, etc. which may be retrieved from, for example, the edge environment 102 (of FIG. 1). While the user interface 902 is illustrated with information provided in a tabular form, this is merely an example, and other arrangements of the fields and user interface elements may also be possible.

In certain embodiments, the user interface 902 may include a plurality of first selectable user interface elements 904 each associated with a unique EVSE. Each of the first selectable user interface elements 904 may be configured, when selected, to generate on the user interface 902 a command type list user interface element 906. As depicted, the command type list user interface element 906 may include a plurality of command type user interface elements 908, each associated with an action to be implemented on the associated EVSE. For example, the command type user interface elements 908 may be related to performing various actions such as start, stop, soft reset, hard reset, etc. on the associated EVSE. As described herein, when the associated EVSE is not ready or available to perform any of these actions (e.g., start, in this example), an associated command type user interface element 908 may be deactivated, such that a user may not select this user interface element. Other command type user interface elements 908 associated with available actions may be activated, such that a user may select these user interface elements. In certain embodiments, whether a command type can or cannot be issued may be based on the state of an associated EVSE. For example, when the EVSE is determined to be in a state that does not support a stop command type (e.g., when the EVSE is already in a stopped state), the command type user interface element 908 associated with the stop command type may be deactivated, and the stop command type would not be able to be issued to the EVSE by selection of the command type user interface element 908 associated with the stop command type on the user interface 902. When the EVSE is determined to be in a state that supports the stop command type (e.g., when the EVSE is in an active state with an active charging session), the command type user interface element 908 associated with the stop command type may be activated, and the stop command type would be able to be issued to the EVSE by selection of the command type user interface element 908 associated with the stop command type on the user interface 902.

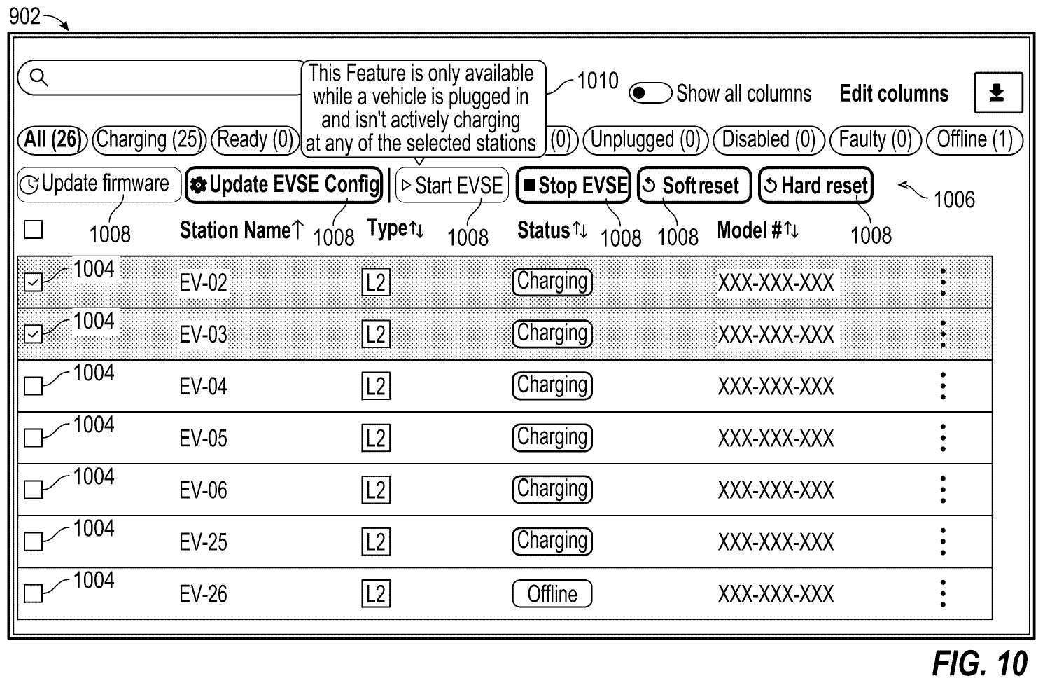

FIG. 10 depicts another example graphical user interface for issuing remote commands for EVSEs, according to embodiments provided herein. As depicted, the user interface 902 may include a plurality of second selectable user interface elements 1004 each associated with a unique EVSE. Each of the second selectable user interface elements 1004 may be configured, when selected, to display an indication (e.g., a check mark) of the selection on the user interface 902. When at least one of the second selectable user interface elements 1004 are selected by a user, a bulk command type list user interface element 1006 may be provided on the user interface 902. As depicted, the bulk command type list user interface element 1006 may include a plurality of bulk command type user interface elements 1008, each associated with an action (e.g., a bulk action) to be implemented on the selected EVSE(s). For example, the bulk command type user interface elements 1008 may be related to performing various actions such as start, stop, soft reset, hard reset, etc. on the selected EVSE(s). In certain embodiments, the bulk command type list user interface element 1006 including the bulk command type user interface elements 1008 may be provided when at least two of the second selectable user interface elements 1004 are selected.

As described herein, when any of the selected EVSE(s) is not ready or available to perform any particular action (e.g., start, in the example shown in FIG. 10), an associated bulk command type user interface element 1008 may be deactivated, such that a user may not select this user interface element. Other bulk command type user interface elements 1008 associated with available actions may be activated, such that a user may select these user interface elements. In this regard, whether a command type can or cannot be issued may be based on the state(s) of associated EVSE(s). For example, when an EVSE is determined to be in a state that does not support a stop command type (e.g., when the EVSE is already in a stopped state), the bulk command type user interface element 1008 associated with the stop command type may be deactivated when the second selectable user interface element 1004 associated with such EVSE is selected on the user interface 902, and the stop command type would not be able to be issued to any of the selected EVSE(s) by selection of the bulk command type user interface element 1008 associated with the stop command type on the user interface 902. When each of the selected EVSE(s) is determined to be in a state that supports the stop command type (e.g., when the EVSE is in an active state with an active charging session), the bulk command type user interface element 1008 associated with the stop command type may be activated, and the stop command type would be able to be issued to the selected EVSE(s) by selection of the bulk command type user interface element 1008 associated with the stop command type on the user interface 902. In certain embodiments, a helper user interface element 1010 may be provided for the deactivated bulk command type user interface element. The helper user interface element 1010 may be provided when, for example, a user attempts to select the deactivated bulk command type user interface element (e.g., by hovering a pointer such as a mouse cursor over the deactivated bulk command type user interface element).

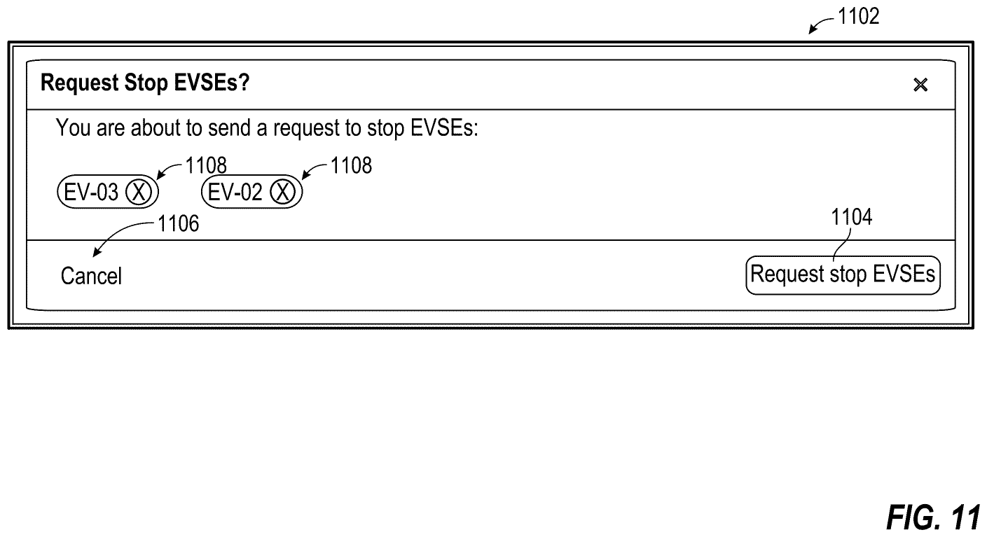

FIG. 11 depicts yet another example graphical user interface for issuing remote commands for EVSEs, according to embodiments provided herein. When a user selects a bulk command type user interface element 1008 shown in FIG. 10 after selecting one or more second selectable user interface elements 1004 (e.g., to select one or more EVSEs to send remote commands of a command type to), a command confirmation user interface element 1102 may be provided. The command confirmation user interface element 1102 may include a confirmation user interface element 1104 configured to, when selected, generate an instruction associated with sending command(s) of the selected command type to the selected EVSE(s). The command confirmation user interface element 1102 may also include a cancellation user interface element 1106 configured to, when selected, not generate any instruction associated with sending command(s) of the selected command type to the selected EVSE(s). In certain embodiments, the command confirmation user interface element 1102 may include one or more third selectable user interface elements 1108 for deselecting one or more of the selected EVSE(s) before an instruction for sending command(s) of the selected command type are generated for the remaining one(s) of the selected EVSE(s). For example, when the command confirmation user interface element 1102 is provided after a plurality of EVSEs have been selected for sending a bulk command of a selected command type to the EVSEs, one of the plurality of EVSEs has been deselected in the command confirmation user interface element 1102 (e.g., by the third selectable user interface element 1108 associated with the EVSE to be deselected), and the confirmation user interface element 1104 is selected, the instruction generated for the bulk command may not include an instruction to generate a command of the selected command type for the deselected EVSE, while including instruction(s) to generate command(s) of the selected command type for the other, remaining EVSE(s).

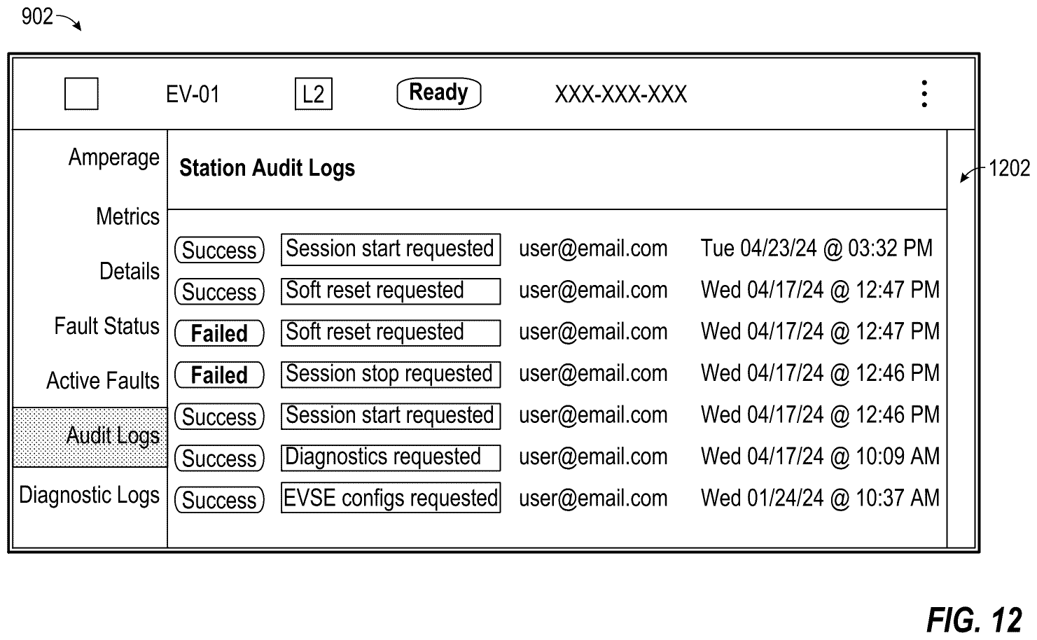

FIG. 12 depicts another example graphical user interface for issuing remote commands for EVSEs, according to embodiments provided herein. As depicted, the user interface 902 may provide a log user interface element 1202. The log user interface element 1202 may display various types of data related to audit logging, including, but not limited to, a result of an action associated with a command of a selected command type (e.g., command status information such as successful, failed, etc.), the selected command type (e.g., start, stop, soft reset, hard reset, etc.), user information (e.g., user identifying information such as user email address), a time and/or date information related to when the command of the selected command type was sent or executed, a command source (e.g., user interface), other identifying information, etc. The proxy server 602 (of FIG. 6) may retrieve the information to be displayed from, for example, one or more components of the edge environment 102 and/or the cloud environment 104 of FIG. 1 For example, the command status information may be determined based on comparing the selected command type and a resulting EVSE state or status (e.g., retrieved after a given amount of time that may account for the commanded action to take effect).

### Processes for Issuing Remote Commands for EVSEs

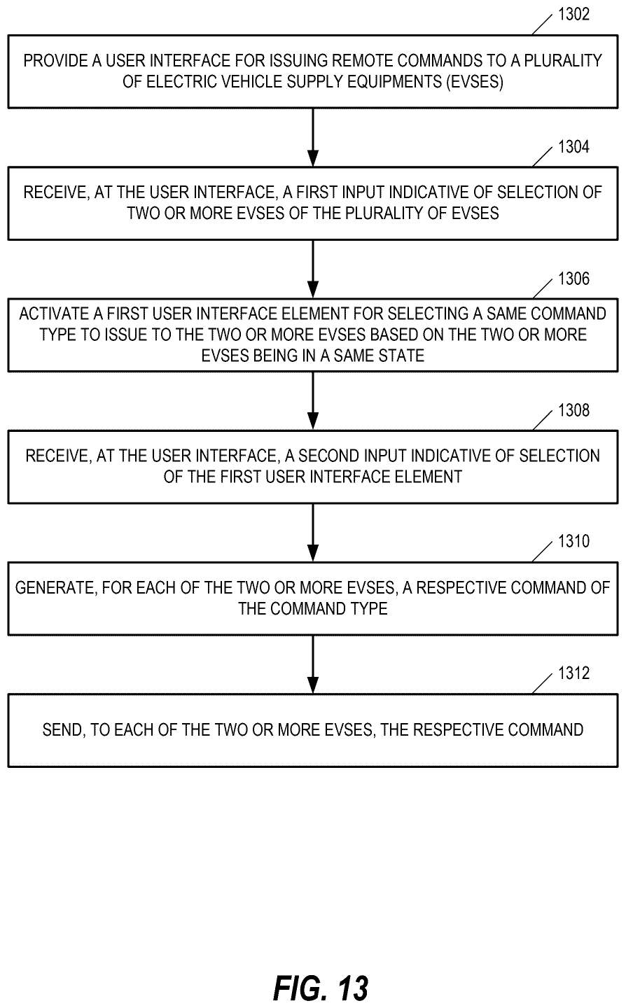

FIG. 13 depicts an example flowchart for illustrating a method for issuing remote commands to EVSEs, according to embodiments provided herein. The method of FIG. 13 may be performed by one or more of the components, such as the proxy server 602 and the device manager 608, shown in and described herein with reference to, for example, FIG. 6.

In step 1302, a user interface for issuing remote commands to a plurality of EVSEs may be provided. For example, the user interface provided for issuing remote commands to the plurality of EVSEs may be or include the user interface 902 of FIG. 9.

In step 1304, a first input indicative of selection of two or more EVSEs of the plurality of EVSEs may be received at the user interface. For example, the selection of two or more EVSEs may be received via corresponding selectable user interface elements 1004 of FIG. 10.

In step 1306, a first user interface element for selecting a same command type to issue to the two or more EVSEs may be activated. In certain embodiments, the activation of the first user interface element may be based on the two or more EVSEs being in a same state. For example, when all of the EVSEs that are selected are in a same charging state (e.g., regarding whether there is any active charging session), the first user interface element associated with, for example, starting or stopping the selected EVSEs may be activated. When there is no active charging session, the state of the selected EVSEs may be a stopped state, and the activated command type may be a start command type. When there is an active charging session, the state of the selected EVSEs may be an active state, and the activated command type may be a stop command type. The first user interface element may correspond to the bulk command type user interface elements 1008 of FIG. 10.

In certain embodiments, other user interface elements corresponding to other bulk command types not supported by at least one of the selected EVSE(s) (and/or its current state such as charging state) may be provided on the user interface (e.g., the user interface 902 of FIG. 9), but may be deactivated, as described herein. After certain EVSE(s) have been selected, selecting additional one or more EVSE(s) may change the activation status of the user interface elements for selecting corresponding command types (e.g., based on whether any of the additionally selected EVSE(s) is in the same state as the other selected EVSE(s) and/or whether the additionally selected EVSE(s) support(s) the command type(s) corresponding to the activated user interface element(s)).

In step 1308, a second input indicative of selection of the first user interface element may be received at the user interface. In certain embodiments, the second input may be followed by a command confirmation user interface element, such as the command confirmation user interface element 1102 of FIG. 11 being displayed, to confirm an intent to send command(s) of the selected command type to the selected EVSE(s). User may deselect one or more of the EVSEs from such command confirmation user interface element, such that corresponding command(s) of the selected command type for the deselected EVSE(s) are not generated.

In step 1310, a respective command of the command type may be generated for each of the two or more EVSEs. For example, the respective command may be generated based on a respective protocol (e.g., communication protocol) that is supported by each of the EVSEs.

In step 1312, the respective command may be sent to each of the two or more EVSEs. The respective commands for the EVSEs may be generated, such as simultaneously or substantially simultaneously, without requiring additional user input, and propagated to the EVSEs in parallel.

In some embodiments, the method of FIG. 13 may also include storing, in an audit log, transaction information regarding sending, to each of the selected EVSEs, the respective command (e.g., as described herein with reference to FIG. 12).

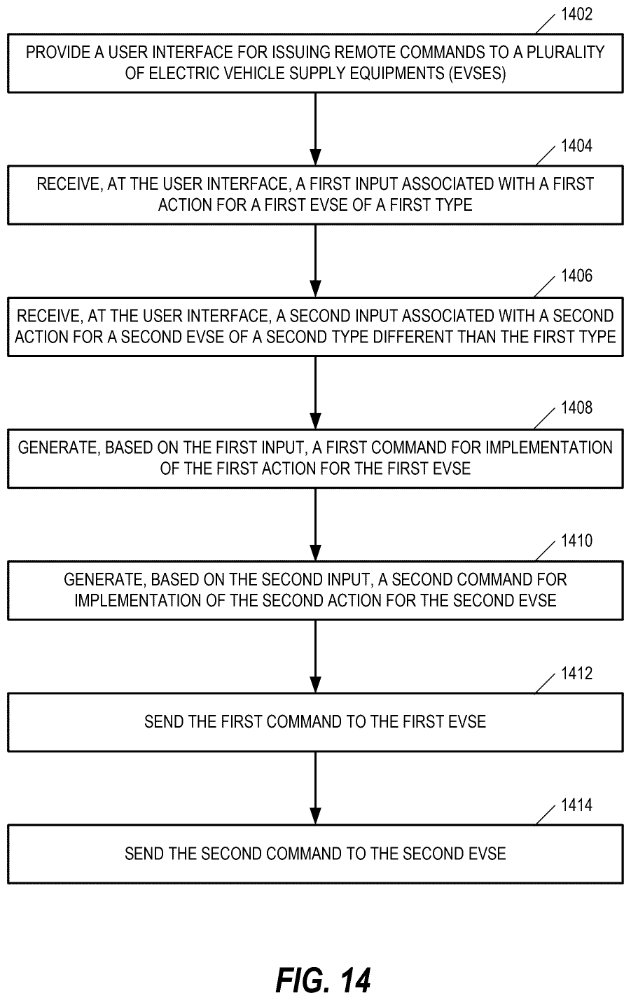

FIG. 14 depicts an example flowchart for illustrating another method for issuing remote commands to EVSEs, according to embodiments provided herein. The method of FIG. 14 may be performed by one or more of the components, such as the proxy server 602 and the device manager 608, shown in and described herein with reference to, for example, FIG. 6

In step 1402, a user interface for issuing remote commands to a plurality of EVSEs, such as the user interface 902 of FIG. 9, may be provided.

In step 1404, a first input associated with a first action for a first EVSE of a first type may be received at the user interface.

In step 1406, a second input associated with a second action for a second EVSE of a second type different than the first type may be received at the user interface.

In certain embodiments, the first EVSE and the second EVSE may be manufactured by different manufacturers. In some embodiments, the first EVSE and the second EVSE may support different communication protocols. For example, the first EVSE may be Open Charge Point Protocol (OCPP)-compliant, and the second EVSE may not be OCPP-compliant.

In step 1408, a first command for implementation of the first action for the first EVSE may be generated based on the first input.

In step 1410, a second command for implementation of the second action for the second EVSE may be generated based on the second input.

In certain embodiments, the first action and the second action may be same actions (e.g., corresponding to a same command type), and the first command and the second command may be or include different commands. For example, the first command and the second command may include different parameters. Moreover, the first command may correspond to a first protocol, and the second command may correspond to a second protocol different than the first protocol. In certain embodiments, a command confirmation user interface element (e.g., the command confirmation user interface element 1102 of FIG. 11) may be provided to confirm an intent to send commands of the selected command type (e.g., corresponding to the same actions) to the selected EVSEs.

In step 1412, the first command may be sent to the first EVSE.

In step 1414, the second command may be sent to the second EVSE.

In some embodiments, the method of FIG. 14 may include deactivating a user interface element associated with a third action for the first EVSE based on a state of the first EVSE not supporting the third action. Moreover, the method of FIG. 14 may include activating a first user interface element associated with the first action based on a state of the first EVSE supporting the first action, wherein receiving the first input may include receiving selection of the first user interface element. In certain embodiments, the method of FIG. 14 may include storing, in an audit log, transaction information regarding sending the first command and the second command (e.g., as described herein with reference to FIG. 12).

### Example Processing System for Issuing Remote Commands for EVSEs

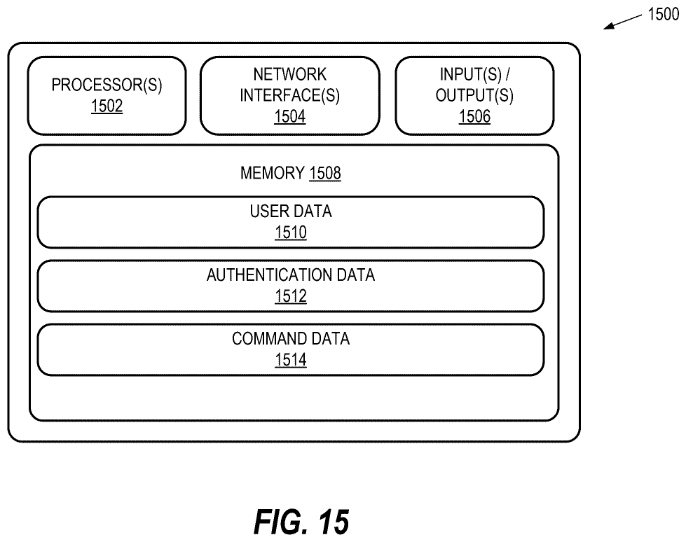

FIG. 15 depicts an example processing system for issuing remote commands for EVSEs, according to embodiments provided herein. In various embodiments, processing system 1500 shown in FIG. 15 may be implemented on, e.g., the proxy server 602 of FIG. 6

As shown, the processing system 1500 may include one or more processors 1502. Generally, the one or more processors 1502 may be configured to execute computer-executable instructions (e.g., software code) to perform various functions, for example, for issuing remote commands to EVSEs, as described herein.

The processing system 1500 may further include one or more network interfaces 1504, which generally provide data access to any sort of data network, including personal area networks (PANs), local area networks (LANs), wide area networks (WANs), the internet, and the like.

Moreover, the processing system 1500 may include input(s) and output(s) 1506, which generally provide means for providing data to and from the processing system 1500, such as via connection to computing device peripherals, including user interface peripherals. In certain embodiments, the input(s) and output(s) 1506 may be provided by, for example, a display device providing a user interface such as the example user interfaces described herein with reference to FIGS. 9-12

The processing system 1500 may also include one or more memories 1508 comprising various components. In this example, the one or more memories 1508 may include user data 1510 (e.g., identity of an operator accessing the proxy server 602 of FIG. 6 via, for example, the example user interfaces of FIGS. 9-12), authentication data 1512 (e.g., regarding one or more roles and/or one or more sites associated with various users, as well as token information related to the token described herein with reference to FIG. 6), and/or command data 1514 (e.g., data related to various command types or commands that may be issued to EVSEs based on user input).

The processing system 1500 may be implemented in various ways. For example, the processing system 1500 may be implemented as a computing device 402 within a core device 302, described herein with respect to FIGS. 3 and 4. In certain embodiments, one or more aspects may be omitted from, added to, or substituted from the processing system 1500.

### Example Clauses

Implementation examples are described in the following numbered clauses:

Clause 1: A method for issuing remote commands for electric vehicle supply equipment (EVSE), comprising: providing a user interface for issuing remote commands to a plurality of EVSEs; receiving, at the user interface, a first input indicative of selection of two or more EVSEs of the plurality of EVSEs; activating a first user interface element for selecting a same command type to issue to the two or more EVSEs based on the two or more EVSEs being in a same state; receiving, at the user interface, a second input indicative of selection of the first user interface element; generating, for each of the two or more EVSEs, a respective command of the command type; and sending, to each of the two or more EVSEs, the respective command.

Clause 2: The method in accordance with clause 1, wherein the state of the two or more EVSEs comprises a charging state of the two or more EVSEs.

Clause 3: The method in accordance with clause 2, wherein: the charging state of the two or more EVSEs comprises a stopped state with no active charging session, and the command type comprises a start command type for starting charging.

Clause 4: The method in accordance with any one of clauses 2-3, wherein: the charging state of the two or more EVSEs comprises an active state with at least one active charging session, and the command type comprises a stop command type for stopping charging.

Clause 5: The method in accordance with any one of clauses 1-4, wherein the command type comprises a reset command type.

Clause 6: The method in accordance with any one of clauses 1-5, further comprising: deactivating a second user interface element associated with another command type based on at least one EVSE of the two or more EVSEs not supporting the other command type.

Clause 7: The method in accordance with any one of clauses 1-6, further comprising: deactivating a second user interface element associated with another command type based on the state not supporting the other command type.

Clause 8: The method in accordance with any one of clauses 1-7, further comprising: receiving, at the user interface, a third input indicative of selection of another two or more EVSEs of the plurality of EVSEs; and deactivating the first user interface element associated with the command type based on at least one of the other two or more EVSEs being in a second state not supporting the command type.

Clause 9: The method in accordance with any one of clauses 1-8, wherein the two or more EVSEs comprise a first EVSE and a second EVSE, the respective command of the first EVSE corresponds to a first protocol, and the respective command of the second EVSE corresponds to a second protocol different than the first protocol.

Clause 10: The method in accordance with any one of clauses 1-9, further comprising: receiving, at the user interface, a third input indicative of confirmation of selection of the first user interface element.

Clause 11: The method in accordance with any one of clauses 1-10, wherein the first input is further indicative of selection of at least one other EVSE of the plurality of EVSEs, wherein the first user interface element is further for selecting the same command type to issue to the at least one other EVSE based on the at least one other EVSE being in the state, and further comprising: based on receiving the second input, providing a command confirmation element comprising a plurality of user interface elements associated with the two or more EVSEs and the at least one other EVSE; receiving, at the user interface, one or more inputs indicative of selection of at least one user interface element, of the plurality of user interface elements, associated with the at least one other EVSE; and based on receiving the one or more inputs, not generating and sending respective commands of the command type for the at least one other EVSE.

Clause 12: The method in accordance with any one of clauses 1-11, further comprising: storing, in an audit log, transaction information regarding sending, to each of the two or more EVSEs, the respective command.

Clause 13: A method for issuing remote commands for EVSE, comprising: providing a user interface for issuing remote commands to a plurality of EVSEs; receiving, at the user interface, a first input associated with a first action for a first EVSE of a first type; receiving, at the user interface, a second input associated with a second action for a second EVSE of a second type different than the first type; generating, based on the first input, a first command for implementation of the first action for the first EVSE; generating, based on the second input, a second command for implementation of the second action for the second EVSE; sending the first command to the first EVSE; and sending the second command to the second EVSE.

Clause 14: The method in accordance with clause 13, wherein the first EVSE and the second EVSE are manufactured by different manufacturers.

Clause 15: The method in accordance with any one of clauses 13-14, wherein the first EVSE and the second EVSE support different communication protocols.

Clause 16: The method in accordance with clause 15, wherein: the first EVSE is Open Charge Point Protocol (OCPP)-compliant, and the second EVSE is not OCPP-compliant.

Clause 17: The method in accordance with any one of clauses 13-16, wherein: the first action and the second action are same actions, and the first command and the second command comprise different commands.

Clause 18: The method in accordance with clause 17, wherein the first command and the second command comprise different parameters.

Clause 19: The method in accordance with any one of clauses 17-18, wherein: the first command corresponds to a first protocol, and the second command corresponds to a second protocol different than the first protocol.

Clause 20: The method in accordance with any one of clauses 13-19, further comprising: receiving, at the user interface, a third input indicative of confirmation of the first input.

Clause 21: The method in accordance with any one of clauses 13-20, further comprising: storing, in an audit log, transaction information regarding sending the first command and the second command.

Clause 22: The method in accordance with any one of clauses 13-21, further comprising: deactivating a first user interface element associated with a third action for the first EVSE based on a state of the first EVSE not supporting the third action.

Clause 23: The method in accordance with any one of clauses 13-22, further comprising: activating a first user interface element associated with the first action based on a state of the first EVSE supporting the first action, wherein receiving the first input comprises receiving selection of the first user interface element.

Clause 24: A processing system, comprising: one or more memories comprising computer-executable instructions; and one or more processors configured to execute the computer-executable instructions and cause the processing system to perform a method in accordance with any one of clauses 1-23.

Clause 25: A processing system, comprising means for performing a method in accordance with any one of clauses 1-23.

Clause 26: A non-transitory computer-readable medium storing program code for causing a processing system to perform the steps of any one of clauses 1-23.

Clause 27: A computer program product embodied on a computer-readable storage medium comprising code for performing a method in accordance with any one of clauses 1-23.

Clause 28: A processing system, comprising: one or more memories; and one or more processors, coupled to the one or more memories, configured to cause the processing system to perform a method in accordance with any one of clauses 1-23.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) (logic) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a memory,” “the processor,” “the memory,” etc.), unless otherwise specifically stated, should be understood to refer to one or more elements (e.g., “one or more processors,” “one or more memories,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., a system) to perform functions, one element may be configured to cause the other element to perform all functions, or more than one element may collectively be configured to cause the other element to perform the functions. Unless specifically stated otherwise, the term “some” refers to one or more. No claim element is to be construed under the provisions of 35 U.S.C. § 112 (f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

While particular embodiments and aspects of the present disclosure have been illustrated and described herein, various other changes and modifications can be made without departing from the spirit and scope of the disclosure. Moreover, although various aspects have been described herein, such aspects need not be utilized in combination. Accordingly, it is therefore intended that the appended claims cover all such changes and modifications that are within the scope of the embodiments shown and described herein.

It should now be understood that embodiments disclosed herein include systems, methods, and non-transitory computer-readable mediums corresponding to issuing remote commands to EVSEs. It should also be understood that these embodiments are merely exemplary and are not intended to limit the scope of this disclosure.

What is claimed is:

1. A method, comprising:
providing a user interface for issuing remote commands to a plurality of electric vehicle supply equipments (EVSEs);
receiving, at the user interface, a first input indicative of selection of two or more EVSEs of the plurality of EVSEs;
activating a first user interface element for selecting a same command type to issue to the two or more EVSEs based on the two or more EVSEs being in a same state;
receiving, at the user interface, a second input indicative of selection of the first user interface element;
generating, for each of the two or more EVSEs, a respective command of the command type; and
sending, to each of the two or more EVSEs, the respective command.

2. The method of claim 1, wherein the state of the two or more EVSEs comprises a charging state of the two or more EVSEs.

3. The method of claim 2, wherein:
the charging state of the two or more EVSEs comprises a stopped state with no active charging session, and
the command type comprises a start command type for starting charging.

4. The method of claim 2, wherein:
the charging state of the two or more EVSEs comprises an active state with at least one active charging session, and
the command type comprises a stop command type for stopping charging.

5. The method of claim 1, wherein the command type comprises a reset command type.

6. The method of claim 1, further comprising:
deactivating a second user interface element associated with another command type based on at least one EVSE of the two or more EVSEs not supporting the other command type.

7. The method of claim 1, further comprising:
deactivating a second user interface element associated with another command type based on the state not supporting the other command type.

8. The method of claim 1, further comprising:
receiving, at the user interface, a third input indicative of selection of another two or more EVSEs of the plurality of EVSEs; and
deactivating the first user interface element associated with the command type based on at least one of the other two or more EVSEs being in a second state not supporting the command type.

9. The method of claim 1, wherein:
the two or more EVSEs comprise a first EVSE and a second EVSE,
the respective command of the first EVSE corresponds to a first protocol, and
the respective command of the second EVSE corresponds to a second protocol different than the first protocol.

10. The method of claim 1, further comprising:
receiving, at the user interface, a third input indicative of confirmation of selection of the first user interface element.

11. A method, comprising:
providing a user interface for issuing remote commands to a plurality of electric vehicle supply equipments (EVSEs);
receiving, at the user interface, a first input associated with a first action for a first EVSE of a first type;
receiving, at the user interface, a second input associated with a second action for a second EVSE of a second type different than the first type;
generating, based on the first input, a first command for implementation of the first action for the first EVSE;
generating, based on the second input, a second command for implementation of the second action for the second EVSE;
sending the first command to the first EVSE; and
sending the second command to the second EVSE.

12. The method of claim 11, wherein the first EVSE and the second EVSE are manufactured by different manufacturers.

13. The method of claim 11, wherein the first EVSE and the second EVSE support different communication protocols.

14. The method of claim 13, wherein:
the first EVSE is Open Charge Point Protocol (OCPP)-compliant, and
the second EVSE is not OCPP-compliant.

15. The method of claim 11, wherein:
the first action and the second action are same actions, and
the first command and the second command comprise different commands.

16. The method of claim 15, wherein the first command and the second command comprise different parameters.

17. The method of claim 15, wherein:
the first command corresponds to a first protocol, and
the second command corresponds to a second protocol different than the first protocol.

18. The method of claim 11, further comprising:
receiving, at the user interface, a third input indicative of confirmation of the first input.

19. The method of claim 11, further comprising:
deactivating a first user interface element associated with a third action for the first EVSE based on a state of the first EVSE not supporting the third action.

20. The method of claim 11, further comprising:
activating a first user interface element associated with the first action based on a state of the first EVSE supporting the first action, wherein receiving the first input comprises receiving selection of the first user interface element.
